(19) United States
(12) Patent Application Publication
(10) Pub. No.: US 2013/0191043 A1
(43) Pub. Date: Jul. 25, 2013

(54) Method and Device for Determining an Estimated Value for at least one Measured Variable of a Wind Turbine

(71) Applicants: Christian Eitner, Muenchen (DE); Felix Hess, Ludwigsburg (DE); Martin Voss, Stuttgart (DE); Boris Buchtala, Muehlacker (DE)

(72) Inventors: Christian Eitner, Muenchen (DE); Felix Hess, Ludwigsburg (DE); Martin Voss, Stuttgart (DE); Boris Buchtala, Muehlacker (DE)

(73) Assignee: Robert Bosh GmbH, Stuttgart (DE)

(21) Appl. No.: 13/704,622

(22) PCT Filed: May 24, 2011
(86) PCT No.: PCT/EP2011/002565

§ 371 Date: Feb. 28, 2013

(30) Foreign Application Priority Data
Jun. 18, 2010 (DE) 10 2010 024 251.9

(51) Int. Cl. F03D 11/00

(52) U.S. Cl. CPC F03D 11/0091
USPC 702/41

(57) ABSTRACT

The disclosure relates to a method for determining an estimated value for at least one measured variable of a wind turbine. The measured variable represents a bending torque on a blade root of a rotor blade of the wind turbine from a rotor plane. The method includes reading in the measured variable and an angle of attack for the rotor blade. The method further includes adapting a model, which simulates an estimated value of the measured variable on the basis of a modeling instruction for a relationship between the measured variable and the angle of attack. The model is adapted using the read-in measured variable and the read-in angle of attack. The method also includes providing the estimated value for the at least one measured variable using the model.

The present invention relates to a method and an apparatus for ascertaining an estimate for at least one measured variable in a wind power installation based on the independent claims.

The control of modern wind power installations in the rated rotation speed range pursues the aim of avoiding overloads which are transferred from the rotor to the drive train and the tower/pod system. To date, collective pitch control (CPC) for all the rotor blades has been applied for this purpose. A change in the pitch angle is used to reduce the aerodynamic incidence angle and hence to achieve a reduction in the lifting force that is responsible for the drive torque. The rotor blades can also be used as aerodynamic brakes by moving them completely into the wind incidence direction in the feathered position or increasing the incidence angle to such an extent that the flow breaks off (stall).

In recent times, a new approach to the control of, by way of example, three-blade wind power installations has increasingly been examined which, in addition to the collective pitch angle, calculates an individual pitch angle for the individual rotor blades. The individual pitch control (IPC) allows a reduction in the asymmetric loads which are transferred to the pod via the hub. This is done by measuring the bending torques acting on the individual rotor blade roots and calculating the individual blade adjustment necessary for reducing the yaw and the pitch torque. The pitch angles calculated from the IPC and CPC control are then sent to the controllers of the relevant pitch actuators as a default setting. The document WO 2008 041066 A1 describes such control, which uses measured torques for controlling the individual pitch angles of the blades of a wind rotor in a wind power installation as a controlled variable.

If one of the sensors for the bending torques on the blade roots fails, however, an IPC controller is no longer provided with sufficient data ensuring optimization of the pitch angles for each of the rotor blades for different incident air flows.

It is the object of the present invention to provide an approach for increased certainty against failure of measured value sensors in a wind power installation.

This object is achieved by a method and an apparatus based on the independent claims.

On account of the need for failsafe mechanisms, it is important, particularly for the operation of an IPC controller, to ensure that the control algorithm is safe even in the event of any sensor failure. The present invention is based on the insight that in the event of failure of the sensor system on a rotor blade in the case of an IPC controller, the load measured variables required for the Coleman transformation are no longer fully available. In this connection, it is also an object of the invention to allow the individual blade control to be able to be maintained even in the event of a sensor failure in a rotor blade. In this regard, it is possible, on the basis of the present approach, to use the sensor signals which continue to be available in order to estimate and provide a relevant sensor variable in a training mode, the estimated sensor variable subsequently being able to be used as an input variable for the controller in the event of actual failure of the sensor variable.

The redundancy function is active in the event of failure of at least one sensor, which means that the IPC controller continues to be active.

Advantageously, such estimation can be implemented within the context of a reduced Luenberger observer. The estimation of the absent measured variables makes it possible to ensure that the IPC controller is safe even in the event of a sensor failure.

The present invention provides a method for ascertaining an estimate for at least one measured variable in a wind power installation, wherein the measured variable represents particularly a bending torque on a blade root of a rotor blade in the wind power installation from a rotor plane. The method comprises the following steps:
the measured variable(s) and a pitch angle for the rotor blade are read in;
a model which simulates an estimate of the measured variable on the basis of a modeling specification for a relationship between the measured variable and the pitch angle is adapted, with the model being adapted by using the read-in measured variable and the read-in pitch angle; and
the estimate for the at least one measured variable is provided by using the model and the pitch angle.

In addition, the invention also comprises a method for controlling a pitch angle for a rotor blade in a wind power installation, wherein the method has the following steps: the steps of the method based on the method cited above; and a step of use of the estimate to determine an individual pitch angle for the rotor blade when the measured variable in the wind power installation is recognized as erroneous and/or is recognized as unusual.

The present invention also provides an apparatus for ascertaining an estimate for at least one measured variable in a wind power installation, wherein the measured variable represents particularly a bending torque on a blade root of a rotor blade in the wind power installation from a rotor plane, wherein the apparatus comprises the following features: a unit for reading in the measured variable and a pitch angle for the rotor blade; a unit for adapting a model which simulates an estimate of the measured variable on the basis of a modeling specification for a relationship between the measured variable and the pitch angle, with the model being adapted by using the read-in measured variable and the read-in pitch angle; and a unit for providing the estimate for the at least one measured variable by using the model.

The measured variable and the estimate can be read in as a numerical value, a binary value or as a direct analogous equivalent of the measured variable, such as a corresponding electrical voltage or a corresponding electrical current. The measured variable can represent a bending torque on the blade root of a rotor blade in a wind power installation. The pitch angle for the rotor blade can actually be measured on the rotor blade, or the setpoint value for a rotor blade adjustment actuator can be read in. The model may comprise a modeling specification. The model may be a state space model for a wind power installation. The model may be based on linearized motion equations for the wind power installation or the like. It is also possible to map nonlinear relationships in another observer model. The model can use the information about the pitch angle of the rotor blade as an input variable. The model can output a simulated or calculated torque loading on the blade root of the rotor blade. The simulated torque loading can substitute the measured variable for the measured variable in the event of failure of the sensor. Use of the estimate for subsequent steps makes it possible to compensate for the failure of one or more measured values and to maintain processes which are dependent on the measured values.

The estimation of the measured variables is an inexpensive alternative to a sensor system of completely redundant design in the wind power installation. In addition, it increases the availability of the wind power installation, since sensors can be interchanged, e.g. in phases of low wind. The desired load reduction, for example on the tower or the pod of the wind power installation, continues to be active, with the result that the IPC controller can continue to be used to advantage.

In this case, a general pitch angle for all the rotor blades is prescribed specifically by the CPC controller (it is read in specifically for control of the pitch actuator, e.g. a hydraulic actuator with control of the piston position for the relevant rotor blade). Assuming sufficient actuator dynamics, the discrepancy in the actual setpoint pitch angle can be ignored here. This means that torques are read in from which the IPC and CPC controllers calculate the actual pitch angles of the rotor blades in the wind power installation. A further relationship may relate to an association between a bending torque and a blade deflection for the relevant rotor blade. The pitch angle is obtained from rotation of the blade about the vertical axis.

The direct relationship between the pitch angle and the measured variable, or the bending torque, is implemented in the IPC controller. The latter reads in the bending torque, with the individual pitch angle correction factor then being determined therefrom in the IPC controller and being linked to the common pitch angle from the CPC controller to produce the pitch angle that is actually used for the rotor blade. The modeling specification may also denote a state space model, linearized about an operating point, for the wind energy installation. The states may be the respective stimuli for the blade eigenmodes, inter alia. The composition of the eigenmodes results in the blade bend. This results in the blade bending torque. Hence, the controller “feeds” firstly the real installation and secondly the state space model of the wind energy installation.

Adaptation of the model of the reduced observer can work on the basis of the known and unknown measured variables. By way of example, all the measured variables are used as a model input, so long as they are known. If a sensor now fails, the model is adapted insofar as a measured variable is now assumed to be unknown (for this, Dim(v)=1 applies, for example, where v is a vector of the unknown measured variables). If two sensors have failed, the model would be activated with Dim(v)=2. By way of example, the known measured variables are used for estimating the unknown measured variables in the model, as in the case of the reduced Luenberger observer, for example. The pitch angle can then be sent from the controller to the model (and the real installation).

Important: The bending torque is not directly a state variable; on the contrary, it is obtained (in simplified form) from M_b=c_Flap*x_Flap, with x_Flap from the state variables, c_Flap from the flexural rigidity in the beat direction (from the rotor plane). x_Flap would describe the bending of the rotor blade. In order to use the information of a known bending torque, for example, x_Flap=M_b/c_Flap would thus be calculated and this variable is then part of the vector of the known state variables.

In accordance with a further embodiment, the step of adaptation involves a reduction in a difference between the estimate and the measured variable by virtue of alteration of the model parameter or of a functional model relationship. The simulated torque loading can be compared with the torque loading that is actually read in. From the difference between the two values, it is possible to derive a correction for the model or the modeling specification which can be used directly to alter the linear or nonlinear relationships or to alter parameters in the model in order to adapt the model to the actual circumstances of the wind power installation.

In this case, a clear distinction can be drawn between two methods. A first method involves: model adaptation, or optimization through parameter identification or adaptation. A second method involves observation (estimation) of unknown states of the model. This is accomplished by using the reduced Luenberger observer, which is based on a fixed model structure, however. Taking account of new functional relationships is difficult in this case. The difference between the reduced observer and the pure observer is the use of the information of known state variables. Both methods could or should be used. However, optimization/adaptation of the model using the known variables should be carried out only until one of the measured variables fails (the model could then become worse again). In that case, sensor failure can prompt activation of the observer and deactivation of the model parameter adaptation.

On the basis of one particular embodiment of the present invention, the steps of the method are executed by using a Luenberger observer model, particularly a reduced Luenberger observer. A Luenberger observer or a corresponding model relates its output signal to an input signal which it simulates by virtue of its model. A difference between the two signals can be used to determine a correction factor or a correction functional relationship for the model, with the result that the model can be corrected by using the information about the error between the input signal and the signal simulated by means of the model. By feeding back the information about the error, for example in the form of a difference between the input signal and the simulated signal, into the model, the model on which the observer is based can be optimized and the error can be minimized.

In a further embodiment of the present invention, the step of reading in involves at least one further measured variable in the wind power installation and a pitch angle for a further rotor blade being read in, wherein the further measured variable represents particularly a bending torque on a blade root of the further rotor blade in the wind power installation from a rotor plane, wherein the step of adaptation involves the model being adapted on the basis of the further measured variable for the further rotor blade, wherein the model is designed to simulate an estimate for the further measured variable on the basis of a relationship between the further measured variable and the pitch angle or the further blade deflection for the further rotor blade and wherein the step of provision involves an estimate for the further measured variable for the further rotor blade being provided. By optimizing the model on the basis of a plurality of rotor blades, it is possible to find a general valid model variant. Such an embodiment of the present invention affords the advantage that it can be ensured that the IPC controller still works actively in the event of failure of a measured variable. In fact, it can be ensured that further measured variables, such as the bending torque measured values from one or the two other rotor blades, can also be estimated by the model. This estimation can also be made on the basis of a plurality of individual models which model an estimation of the measured variable for a respective rotor blade. In this case, the model would contain a plurality of submodels, for example one for each measured variable that is to be simulated for a rotor blade. This ensures that the IPC controller still works reliably even in the event of more than one sensor failing.

It is also beneficial when the step of use involves the individual pitch angle being determined on the basis of the measured variable when the measured variable in the wind power installation is recognized as free of error and/or is recognized as available. The measured values correspond to the actual states on the rotor blade. It is thus possible to avoid inaccuracies as a result of approximated or estimated measured variables.

In addition, a common pitch angle can also be ascertained which is used for determining the pitch angle of the wind power installation, wherein the pitch angle is determined for every single one of the rotor blades on the basis of the common pitch angle and the individual pitch angle.

Another advantage is a computer program product having program code which is stored on a machine-readable storage medium such as a semiconductor memory, a hard disk memory or an optical memory and which is used to carry out the method according to one of the embodiments described above when the program is executed on a controller or an apparatus.

The invention is explained in more detail by way of example below with reference to the appended drawings, in which:

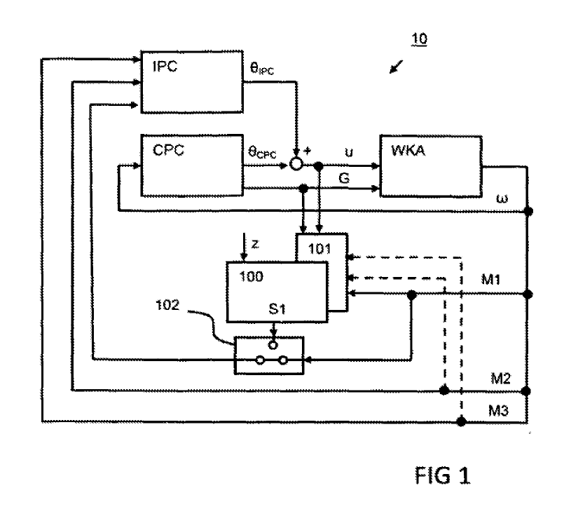

FIG. 1 shows a block diagram of an exemplary embodiment of an apparatus for ascertaining an estimate based on the approach presented here in a learning phase;

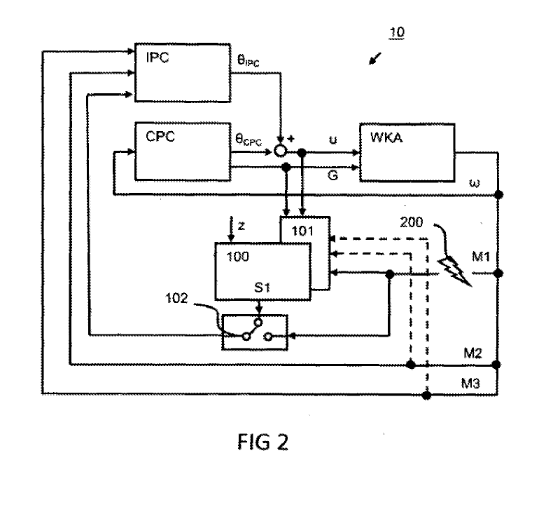

FIG. 2 shows a block diagram of an exemplary embodiment of an apparatus for ascertaining an estimate based on the approach presented here in a phase in which an erroneous or absent signal for a measured variable in the wind power installation has occurred; and

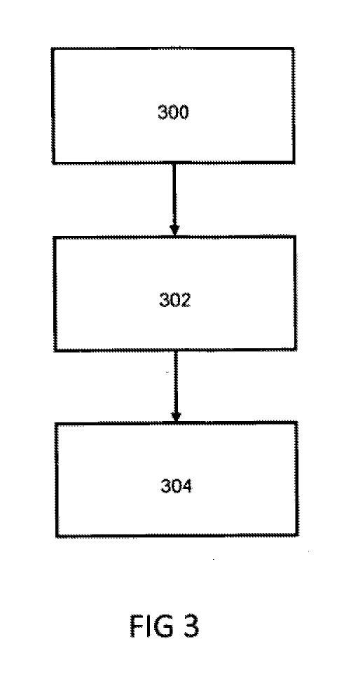

FIG. 3 shows a flowchart for an exemplary embodiment of a method for ascertaining an estimate based on the approach presented here.

Elements having the same or a similar action may be provided with the same or similar reference symbols in the figures which follow. In addition, the figures of the drawings, the description thereof and also the claims contain numerous features in combination. In this context, it is clear to a person skilled in the art that these features can also be considered individually or that they can be combined to form further combinations which are not described explicitly here. In addition, the description which follows may explain the invention by using different measurements and dimensions, with the invention not being intended to be understood as being restricted to these measurements and dimensions. Furthermore, method steps according to the invention can be carried out repeatedly and also in an order that is different than the one described. If an exemplary embodiment comprises an “and/or” conjunction between the first feature/step and the second feature/step, this can be read to mean that the exemplary embodiment has both the first feature/the first step and the second feature/the second step on the basis of one embodiment and either just the first feature/the first step or just the second feature/the second step on the basis of a further embodiment.

FIGS. 1 and 2 each show a block diagram of an exemplary embodiment of an apparatus for ascertaining an estimate based on the approach presented here in order to clarify an implementation of a measured variable estimation method for the individual blade control in a wind power installation WKA. A conventional controller for a wind power installation WKA, comprising a pitch angle controller CPC for a common pitch angle for all the rotor blades, takes the rotation speed ω of a rotor in the wind power installation WKA and other performance parameters from the wind power installation WKA as a basis for outputting a pitch angle θ_{CPC} for all the rotor blades in the wind power installation WKA. In addition, the CPC controller forwards the generator torque to the wind power installation in order to achieve an appropriate setting for the wind power installation. To be absolutely precise, the block CPC shown in the figures comprises the management of conventional installations a pitch controller and a generator controller. In the present case, the CPC controller is therefore understood to mean a controller which represents the management of the wind power installation. In order to minimize torques in the yaw and pitch directions, an individual pitch angle controller IPC additionally engages in the control. The individual pitch angle controller IPC provides a pitch angle correction angle θ_{IPC} for every single rotor blade in the wind power installation WKA. The collective pitch angle θ_{CPC} and the individual pitch angle correction angle θ_{IPC} are linked to one another, for example linked additively. This forms a pitch angle u as a setpoint value for blade adjustment for each rotor blade in the wind power installation WKA and supplies it to the wind power installation WKA.

FIG. 1 shows a circuit for the illustrated components for a learning phase. In the learning phase, the individual pitch angle controller IPC receives signals M1, M2, M3 relating to the torques acting on each of the three rotor blades in the wind power installation. Operating in parallel therewith is an observer 100. Via an interface or unit for reading in 101, the observer 100 receives the pitch angle u for a rotor blade in the wind power installation WKA and the generator torque G as a controlled variable. In the present case, this would be the pitch angle for the rotor blade on which the sensor outputs the measured variable, e.g. the bending torque, M1. In addition, the observer 100 also receives still further measured variables, such as the bending torques M2 and M3 on the blade root of the other rotor blades, and also an auxiliary variable z, for example. This auxiliary variable allows it a certain flexibility for the adaptation of an observer model, which is subsequently also referred to as a model for the sake of simplicity. On the basis of a model of the wind power installation WKA, the observer 100 outputs a signal S1 which corresponds to the signal M1 about the torques acting on the rotor blade in the wind power installation. Since the signal S1 from the observer 100 is not applied in the learning phase, a switch 102 prevents the signal S1 from being supplied to the inputs of the individual pitch angle controller IPC. In order to continually improve the model from the observer 100, the observer 100 receives the actual signal M1 about the torques acting on the rotor blade when the measured variable M1 represents a torque on the rotor blade. The output signal S1 from the observer 100 and the actual signal M1 from the rotor blade are continually compared with one another, and the difference is used to form a correction parameter or a correction functional relationship in order to continually improve the model in the observer 100.

FIG. 2 shows a circuit for the illustrated components from the block diagram shown in FIG. 1 for a phase in which an erroneous or absent signal for a measured variable in the wind power installation has occurred. The signal M1 about the torques or the bending torque acting on the rotor blade in the wind power installation WKA is subject to a disturbance, this being shown by the arrow 200. This disturbance may be caused by failure of the sensor for the measured variable Ml, line breakage in the lines to or from the sensor for the measured variable M1 or another fault. The individual pitch angle controller IPC thus lacks one of the input signals M1, M2, M3 in order to be able to provide the pitch angle correction angle θ_{IPC} as desired. Upon recognition of such a case in which the signal from the sensor for the measured variable M1 is subject to a disturbance (i.e. defective) or totally absent, a switch 102 is operated, and the output signal S1 from the observer 100 replaces the disturbed signal M1 about the torques acting on the rotor blade. This switch 102 can also be controlled automatically when the signal from the sensor for the measured variable M1 is recognized as erroneous or absent. As a result, the individual pitch angle controller IPC can provide the pitch angle correction angle θ_{IPC} again as desired. As a controlled variable, the observer 100 continues to receive the pitch angle u for a rotor blade in the wind power installation WKA and the auxiliary variable z. Since the signal M1 about the torques acting on the rotor blade is subject to a disturbance, the observer 100 cannot perform further optimization for the model, however. The model in the observer 100, which model is optimized up to the time of the disturbance 200, now replaces the actual measurement on the rotor blade. In other words, the trained model uses the pitch angle to simulate the measured variable that is to be expected for M1, which in all likelihood has been delivered by the sensor if the sensor would deliver an error-free measured variable. The pitch angle controller CPC for the common pitch angle θ_{CPC} continues to output the collective pitch angle θ_{CPC} for all the rotor blades in the wind power installation WKA, on the basis of the rotation speed ω of the rotor in the wind power installation WKA and other performance parameters in the wind power installation WKA.

The block diagram shown in FIGS. 1 and 2 shows an arrangement of components for estimating the measured variable M1 and using the estimated measured variable M1 for the IPC control in that case in which the measured variable that has been measured is not available in error-free form. However, it is also evident that in an exemplary embodiment which is not shown here for reasons of simplicity, it is also possible to use an estimation for the measured variable M2 and/or the measured variable M3 which is similar to the estimation of the measured variable M1 by virtue of the use of an appropriately trained model. This ensures that not only a measured variable or sensor variable is protected against failure in the IPC controller, but rather that the IPC controller can use the estimated measured variables M1, M2 and M3 in the worst case when all the sensors for the measured variables M1, M2 and M3 have failed or deliver measurement signals which are subject to a disturbance.

In general, the observer can be implemented as a pure observer. To this end, it is possible to assume an estimation of all three bending torques on the basis of the previously identified model or to use a reduced observer. This use of the reduced observer has the advantage that it is also possible to use information of known state variables. Both could be based on the previously optimized learning model.

For the implementation of the measured variable assessment, it is therefore advantageous to create a state space model in the observer, for example on the basis of the linearized motion equations for the wind power installation. It is appropriate to create a respective linearized model for various operating points or different loading intensities to activate the respective relevant model via the management. These individual models can then be interchanged with one another during the step of adaptation. The bending torque loadings, preferably in the beat and swivel directions, respectively, are classified into known and unknown state variables in the event of a sensor failure on a rotor blade. The state space representation is shown in accordance with the known and unknown variables on the basis of the equation below.

$$[ \begin{matrix}\dot{y} \\ \dot{v}\end{matrix} ] = [ \begin{matrix}{A}_{11} & {A}_{12} \\ {A}_{21} & {A}_{22}\end{matrix} ] [ \begin{matrix}y \\ v\end{matrix} ] + [ \begin{matrix}{B}_{1} \\ {B}_{2}\end{matrix} ] u$$

In the equation above, the variable y corresponds to the known measured variables and the variable v corresponds to the unknown measured variables. Following conversion, the equation below is obtained for the variables that are to be assessed.

z=(A₂₂−KA₁₂)z+(B₂−KB₁)u+[(A₂₂−KA₁₂)K+(A₂₁−KA₁₁)]y

\hat{v}=z+Ky

In the equations above, the variable z is an auxiliary variable, \hat{v} is the estimate of the absent (or erroneous) sensor variable or sensor variables, and the coefficients of K are used to stipulate the eigenvalues of the observer or the observer matrix thereof.

FIG. 3 shows a flowchart for an exemplary embodiment of a method for ascertaining an estimate on the basis of the approach presented here. The method comprises a step of reading in 300, a step of adapting 302 and a step of providing 304. The step of reading in 300 involves a measured variable being read in which represents particularly a bending torque on a blade root of a rotor blade in a wind power installation. In addition, a signal is read in which represents a pitch angle of the rotor blade. The step of adapting 302 involves a model being adapted. The model takes a modeling specification as a basis for outputting an estimate for the measured variable. The modeling specification maps a relationship between the measured variable and the pitch angle. For adaptation, the estimate from the model is compared with the measured variable that has been measured, and, by way of example, the difference between the estimate for the measured variable and the measured variable that has been read in forms the basis for adapting the model. This difference should then beneficially be minimized. The model can be adapted by changing one or more of the variables in the model, but also by virtue of alterations in the modeling specification. The step of providing 304 involves the estimate from the model being provided for subsequent methods.

The exemplary embodiments shown are chosen merely by way of example and can be combined with one another.

1. A method for ascertaining an estimate for at least one measured variable in a wind power installation, the measured variable representing a bending torque on a blade root of a rotor blade in the wind power installation from a rotor plane, comprising:
reading in the measured variable and a pitch angle for the rotor blade;
adapting a model which simulates an estimate of the measured variable on the basis of a modeling specification for a relationship between the measured variable and the pitch angle, wherein the model is adapted by using the read-in measured variable and the read-in pitch angle; and
providing the estimate for the at least one measured variable by using the model.

2. The method as claimed in claim 1, wherein the adapting includes a reduction in a difference between the estimate and the measured variable by virtue of alteration of a model parameter or of a functional model relationship.

3. The method as claimed in e claim 1, wherein the method is executed by using a a reduced Luenberger observer model.

4. The method as claimed in claim 1, wherein:
the reading in includes reading in at least one further measured variable in the wind power installation and a pitch angle for a further rotor blade
the further measured variable represents a bending torque on a blade root of the further rotor blade in the wind power installation from a rotor plane,
the adapting includes the model being adapted on the basis of the further measured variable for the further rotor blade,
the model is configured to simulate an estimate for the further measured variable on the basis of a relationship between the further measured variable and the pitch angle for the further rotor blade, and
the providing includes providing an estimate for the further measured variable for the further rotor blade.

5. The A method as claimed in claim 1, further comprising:
using of the estimate to determine an individual pitch angle for the rotor blade when the measured variable in the wind power installation is recognized as erroneous and/or is recognized as unusual.

6. The method as claimed in claim 5, wherein the using includes the individual pitch angle being determined on the basis of the measured variable when the measured variable in the wind power installation is recognized as free of error and/or is recognized as available.

7. The method as claimed in claim 5, wherein:
a common pitch angle is also ascertained which is used for determining the pitch angle of the wind power installation, and
the pitch angle is determined for every single one of the rotor blades on the basis of the common pitch angle and the individual pitch angle.

8. An apparatus for ascertaining an estimate for at least one measured variable in a wind power installation, the measured variable representing a bending torque on a blade root of a rotor blade in the wind power installation from a rotor plane, comprising:
a first unit configured to read in the measured variable and a pitch angle for the rotor blade;
a second unit configured to adapt a model which simulates an estimate of the measured variable on the basis of a modeling specification for a relationship between the measured variable and the pitch angle, wherein the model is adapted by using the read-in measured variable and the read-in pitch angle; and
a third unit configured to provide the estimate for the at least one measured variable by using the model.

9. A computer program product comprising:
a program code for carrying out a method when the program code is executed on an apparatus,
wherein the apparatus includes a first unit, a second unit, and a third unit,
wherein the method is for ascertaining an estimate for at least one measured variable in a wind power installation,
wherein the measured variable represents a bending torque on a blade root of a rotor blade in the wind power installation from a rotor plane, and
wherein the method includes (i) reading in the measured variable and a pitch angle -u4 for the rotor blade with the first unit, (ii) adapting a model which simulates an estimate of the measured variable on the basis of a modeling specification for a relationship between the measured variable and the pitch angle with the second unit, wherein the model is adapted by using the read-in measured variable and the read-in pitch angle, and (iii) providing the estimate for the at least one measured variable by using the model with the third unit.
